(19) United States
(12) Patent Application Publication
(10) Pub. No.: US 2021/0192993 A1
(43) Pub. Date: Jun. 24, 2021

(54) RETRACTABLE FLAG ENCLOSURE APPARATUS

(71) Applicant: Gilbert Garcia, Ontario, CA (US)

(72) Inventor: Gilbert Garcia, Ontario, CA (US)

(21) Appl. No.: 16/921,474

(22) Filed: Jul. 6, 2020

Related U.S. Application Data
(60) Provisional application No. 62/951,719, filed on Dec. 20, 2019.
(60) Provisional application No. 62/978,583, filed on Feb. 19, 2020.

(51) Int. Cl. G09F 17/00

(52) U.S. Cl. CPC G09F 17/00; G09F 2017/0066; G09F 2017/005; G09F 2017/0025

(57) ABSTRACT

A retractable flag enclosure apparatus has an enclosure shell that has an aperture. The retractable flag enclosure apparatus also has a knob operably attached to a top end of the enclosure shell. Additionally, the retractable flag enclosure apparatus has a primary dowel and a secondary dowel. Furthermore, the retractable flag enclosure apparatus has flag with a first end adhered to the primary dowel. The flag and the primary dowel are positioned within the enclosure shell such that a portion of the flag is retracted through the aperture via motion applied to the knob and a portion of the flag is pulled through the aperture. Also, the flag has a second end that is adhered to the secondary dowel such that the secondary dowel is positioned on the exterior of the aperture and prevented from entering the enclosure shell.

### RELATED APPLICATIONS

This application claims priority to U.S. Provisional Patent Application Ser. No. 62/951,719, filed on Dec. 20, 2019, and U.S. Provisional Patent Application Ser. No. 62/978,583, filed on Feb. 19, 2020, all of which are hereby incorporated by reference in their entireties.

### BACKGROUND

### 1. Field

This disclosure generally relates to flags. More particularly, the disclosure relates to an apparatus for enclosing a flag.

### 2. General Background

Flags are a common form of expression utilized for a variety of purposes. For example, some people adorn their homes, or attend public gatherings, with a flag representative of their home country; others may do the same with a flag representative of their favorite sports team. All-in-all, a flag can be a great source of pride and inspiration.

However, flags are typically subject to significant wear-and-tear, often leading to frequent replacement. For example, one typical configuration for holding a flag is a flag pole, which is typically adhered to the exterior of a dwelling, or in close proximity thereto (e.g., in a front yard). However, the flag pole configuration is quite susceptible to inclement weather: rain, snow, and wind can easily damage the flag that is being held by the flag pole configuration. For instance, tears in flags are not uncommon after a storm. And even if the flag does not tear during inclement weather, at a minimum, it is quite likely to get dirty. Furthermore, the flag is likely to get tangled around the flag pole, leading users to having to deal with the inconvenience of detangling the flag. Additionally, the flag pole, itself, is often fabricated from a metal that is prone to rust, which can lead to breakage of the flag pole.

To avoid the pitfalls of keeping a flag pole all year round, many users opt for taking the flag down during the fall or winter seasons, or at the onset of inclement weather. The flag will typically be folded and stored away, where it is further prone to aggregating dirt. Furthermore, such maintenance of flags is an added inconvenience for most users.

Finally, a configuration such as a flag pole holder is limited in its applicability, given that it is intended to hold a flag in a fixed position. For example, a typical flag pole holder is adhered to the exterior of a dwelling (e.g., via a fastener such as a screw, bolt, etc.), thereby restricting movement of the flag pole and flag. A user could remove the flag pole from the flag pole holder, but travelling in such a manner has a probability of leading to a tangled flag—just more inconvenience to the user.

Accordingly, current flag holding configurations are inadequate for storage and durability.

### SUMMARY

In one embodiment, a retractable flag enclosure apparatus has an enclosure shell that has an aperture. The retractable flag enclosure apparatus also has a knob operably attached to a top end of the enclosure shell. Additionally, the retractable flag enclosure apparatus has a primary dowel and a secondary dowel. Furthermore, the retractable flag enclosure apparatus has flag with a first end adhered to the primary dowel. The flag and the primary dowel are positioned within the enclosure shell such that a portion of the flag is retracted through the aperture via motion applied to the knob and a portion of the flag is pulled through the aperture. Also, the flag has a second end that is adhered to the secondary dowel such that the secondary dowel is positioned on the exterior of the aperture and prevented from entering the enclosure shell.

In another embodiment, the retractable flag enclosure apparatus has a spring roller. Accordingly, the flag and the primary dowel are positioned within the enclosure shell such that a portion of the flag is retracted through the aperture via the spring roller and a portion of the flag is pulled through the aperture.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a disassembly of a retractable flag enclosure apparatus.

FIG. 2A illustrates the primary dowel along with the rolled up flag being positioned within the enclosure shell.

FIG. 2B illustrates the end of the flag, which is not attached to the primary dowel, being pulled through the aperture.

FIG. 3A illustrates the secondary dowel being positioned at one end of the flag.

FIG. 3B illustrates a portion of the flag being stitched over the secondary dowel.

FIG. 4A illustrates a front perspective view of the knob as it is about to engage the cap.

FIG. 4B illustrates a side perspective view of the knob illustrated in FIG. 4A.

FIG. 5A illustrates the detachable handle being attached to the bushing core through the bushing casing.

FIG. 5B illustrates an expanded view of the detachable handle being attached to the enclosure shell.

FIG. 6 illustrates an assembled retractable flag enclosure apparatus illustrated in FIG. 1.

FIG. 7A illustrates the user pulling the flag, via the secondary dowel enclosure, from the enclosure shell.

FIG. 7B illustrates the user twisting the knob to retract the flag within the enclosure shell.

FIG. 8 illustrates the assembled retractable flag enclosure apparatus being vertically hung from a vehicle.

FIG. 9A illustrates a socket within a cap.

FIG. 9B illustrates the cap being positioned on the spring roller.

FIG. 9C illustrates the retractable flag enclosure apparatus with the spring roller.

### DETAILED DESCRIPTION

A retractable flag enclosure apparatus is provided for enclosing a flag. Having the versatility of being portable, the retractable flag enclosure apparatus allows a user to bring a flag to various locations in a manner that protects the flag both from inclement weather and entanglement. Via various enclosure mechanisms, the retractable flag enclosure apparatus allows for a flag to withdrawn into the retractable flag enclosure apparatus to avoid the wear-and-tear of typical flag holder configurations that allow for full exposure of the flag. Furthermore, a stitched dowel within the flag prevents the flag from wrapping around the retractable flag enclosure apparatus. Finally, the retractable flag enclosure apparatus has one or more connection mechanisms that allow the retractable flag enclosure apparatus to be hung in a static position, horizontally or vertically, from a variety of structures (e.g., dwellings, automobiles, etc.).

In one embodiment, the retractable flag enclosure apparatus is manually retractable. For example, a user may manually twist a knob to retract the flag into the retractable flag enclosure apparatus. In other words, the user may manually roll up the flag into the retractable flag enclosure apparatus. In another embodiment, the retractable flag enclosure apparatus is automatically retractable. For example, the retractable flag enclosure apparatus may have an integrated spring roller device that, upon a pulling movement of the flag performed by the user, automatically retracts the flag into the retractable flag enclosure apparatus.

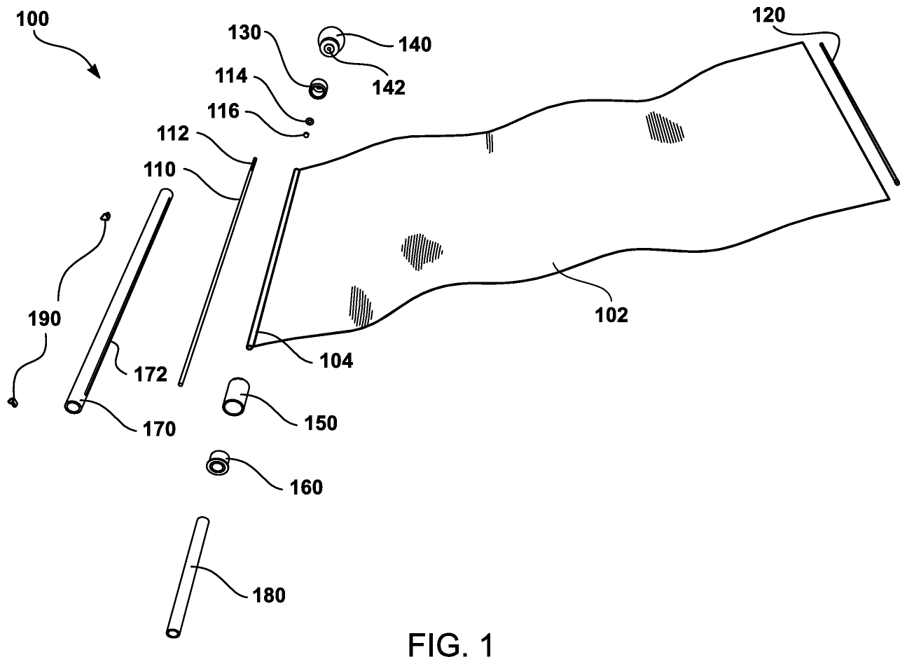

FIG. 1 illustrates a disassembly of a retractable flag enclosure apparatus 100. In particular, the retractable flag enclosure apparatus 100 may have an enclosure shell 170, in which a flag 102 is positioned for pull and retraction. (The flag 102 is illustrated without any emblems for illustrative purposes. However, a variety of emblems representing various entities (e.g., nations, cities, towns, villages, sports teams, organizations, corporations, etc.) may be integrated within, or attached to, the flag 102.)

Given varying dimensions of flags, the enclosure shell 170 may be customized to the particular dimensions of the flag 102. For example, if the height of the flag 102 is twelve inches (measured as the flag is intended to be displayed), then the enclosure shell 170 may be fourteen inches in length to accommodate the height of the flag 102, and allow for additional room for other componentry. (This example is not intended to be limiting, given that flags of varying heights may be utilized. Also, varying degrees of additional space in the enclosure shell 170 may be necessary to accommodate for componentry of varying sizes.) The enclosure shell 170 may be constructed from various materials (e.g., polyvinyl chloride (“PVC”), plastic, metal, bamboo, fiberglass, etc.), which may allow for customization to the size of the flag 102. For instance, the enclosure shell 170 may be a PVC pipe, which may be cut lengthwise to accommodate the size of the flag 102. (Various tools, such as a table saw, skill saw, or PVC cutters may be used to perform the cutting of the enclosure shell 170.) The use of a material such as PVC is one example of a rust-proof material that provides added protection for the flag 102. Alternatively, a particular enclosure shell 170 that accommodates a particular flag 102, without any cutting, may be selected for use with the flag 102. In essence, the enclosure shell 170 may be a tube in which the flag 102 is positioned for pull and retraction. Also, the enclosure shell 170 may be selected to have a particular diameter (e.g., one inch) to accommodate the flag 102 when fully rolled up. Furthermore, the flag 102, itself, may be manufactured from various materials (e.g., fabric, plastic, etc.) that are capable of being rolled up for enclosure within the enclosure shell 170.

Additionally, to ensure a snug, yet ample, retraction and release of the flag 102, an aperture 172 (e.g., slit) may be formed within the enclosure shell 170. For example, a cutting implement (e.g., table saw, skill saw, or PVC cutters) may be utilized to cut the aperture 172 within the enclosure shell 170. The aperture 172 may be opened more with additional tools (e.g., a multi-tool) to provide a further opening for the pull and retraction of the flag 102. Furthermore, the inner portions of the aperture 172 may be smoothed (e.g., sanded with sand paper) to avoid the flag 102 from getting caught on any snags (e.g., rough edges), which could lead to tears, when pulled or retracted from the enclosure shell 170. Moreover, the enclosure shell 170 may be sanded to allow for paint to adhere better to it.

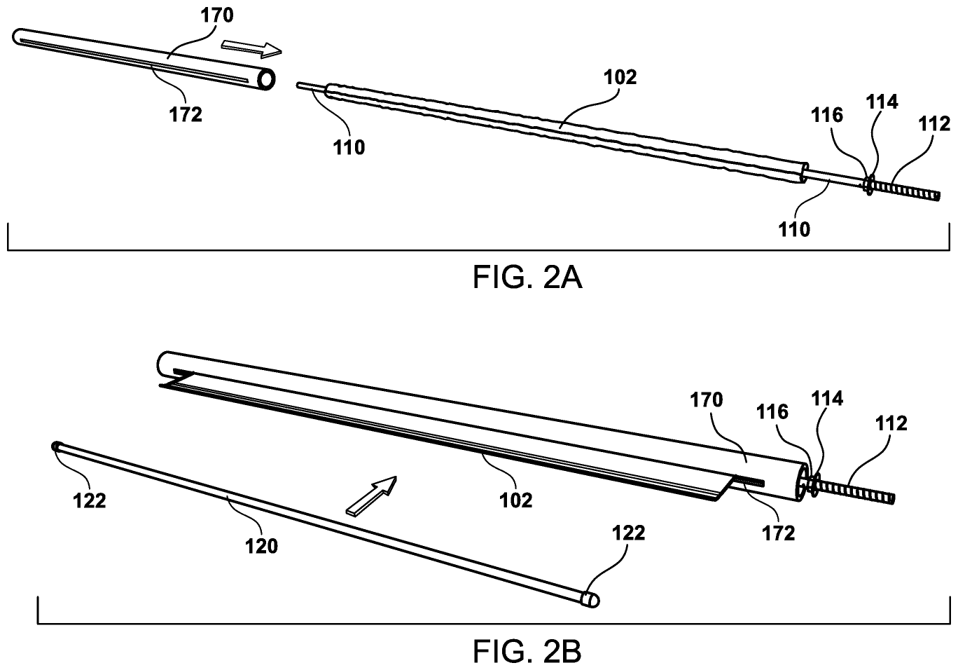

In order to position, the flag 102, whether in retracted or released form, within the enclosure shell 170, a primary dowel 110 is utilized. (The term “dowel” is used herein to connote a rod, which may be geometrically-shaped (e.g., cylindrically-shaped). It may be constructed from various materials, such as wood, bamboo, plastic, or metal.) In one embodiment, one end of the flag 102 (e.g., the left side of the flag 102) has a flag sleeve 104 through which the primary dowel 110 may be positioned. In an alternative embodiment, the primary dowel 110 may be attached to the flag 102 via an adherent (e.g., glue, staples, stitching, etc.). Once adhered to one end of the flag 102, the flag 102 may be rolled around the primary dowel 110, as illustrated in FIG. 2A for subsequent placement within the enclosure shell 170. The primary dowel 110 may have a diameter (e.g., three-eighths of an inch) to allow for the flag 102 to fit within the enclosure shell 170 when rolled up.

Returning to FIG. 1, the primary dowel 110 may be threaded with a threading 112 to allow for positioning of a nut 116 (e.g., hex nut) and a washer 114 thereon. (A threading tool may be utilized to obtain the threading 112.) Furthermore, the enclosure shell 170 may have two openings, one on each end. After the flag 102 is rolled up on the primary dowel 110, the flag 102 along with the primary dowel 110 may be positioned within the enclosure shell 170. (Prior to such positioning, a push stick may be utilized to clean debris out of the enclosure shell 170.)

To maintain the positioning of the primary dowel 110, along with the rolled up flag 102, within the enclosure shell 170, various components may be utilized to close off the ends of the enclosure shell 170. For example, a cap 130 may be positioned at a top end of the enclosure shell 170. An aperture 172 may be positioned through the cap 130 to allow access to the washer 114 and nut 116. The cap 130 may be adhered to the top end of the enclosure shell 170 via an adherent (e.g., glue). Furthermore, a knob 140 may be positioned on top of the cap 130 to engage the washer 114 and nut 116. For instance, the knob 140 may have a socket 142 that may engage the washer 114 and nut 116. As a result of such engagement, a turn of the knob 140 results in a turn of the primary dowel 110, allowing for unrolling or rolling of the flag 102. Other turning mechanisms besides the knob 140 may be used in place of the knob 140.

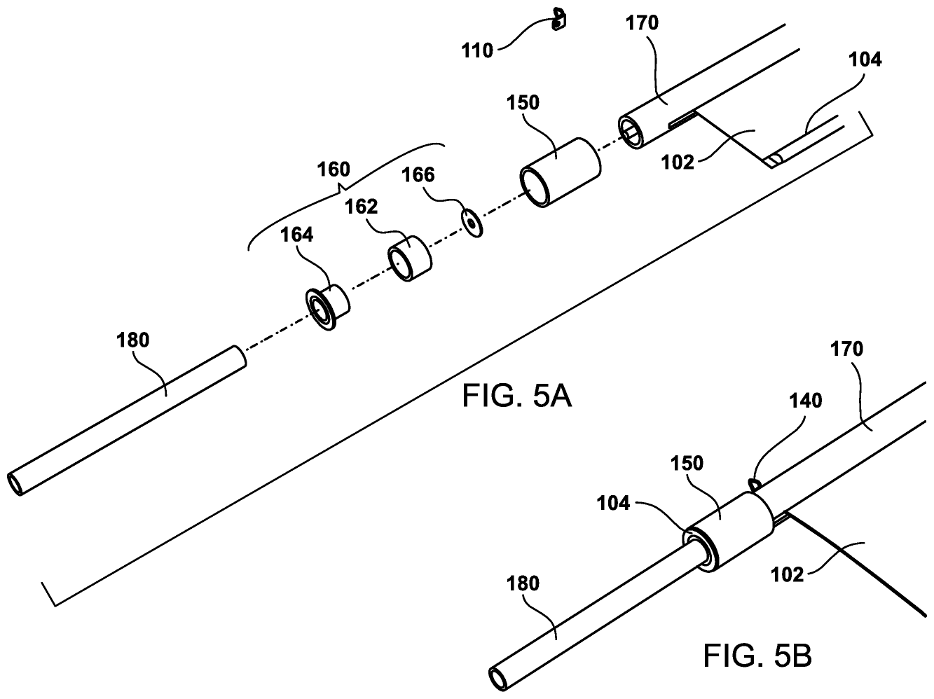

With respect to the opposite end of the enclosure shell 170, a coupling 150 may be attached thereto (e.g., via an adherent such as glue). Furthermore, a bushing 160 may be inserted into the bottom end of the coupling 150. The bushing 160 allows the enclosure shell 170 to be connected to a detachable handle 180. (The bushing 160 is just one example of a connector that may be utilized to connect the detachable handle 180 to the enclosure shell 170; for example, the detachable handle 180 could potentially be directly connected to a coupling 150 that is configured to receive the detachable handle 180.) In one embodiment, the bushing 160 has a bushing casing 162, a bushing core 164, and a bushing washer 166, illustrated in FIG. 5A; all of which may be utilized for connection to the detachable handle 180.

In contrast with previous flag pole holding configurations, the detachable handle 180 allows for convenient portability of the flag 102. A user could just as easily attach the enclosure shell 170 with the flag 102, via the detachable handle 180, as take it to a sporting event for grasping with one or more hands to hold or wave the flag 102. Upon completing usage of the flag 102, the user can easily remove the detachable handle 180 from the enclosure shell 170 to allow for light and convenient transportation. For example, some vehicles may not be able to accommodate the full length of the retractable flag enclosure apparatus 100, but may be able to do so if the detachable handle 180 is detached from the enclosure shell 170.

Additionally, one or more connection mechanisms 190 (e.g., hooks) may be adhered to the enclosure shell 170. The one or more connection mechanisms 190 allow for convenient hanging of the enclosure shell 170 from various structures (e.g., buildings, vehicles, etc.).

FIGS. 2A and 2B illustrate assembly of the retractable flag enclosure apparatus 100 illustrated in FIG. 1. In particular, FIG. 2A illustrates the primary dowel 110 along with the rolled up flag 102 being positioned within the enclosure shell 170. Furthermore, FIG. 2B illustrates the end of the flag, which is not attached to the primary dowel 110, being pulled through the aperture 172. A secondary dowel 120 may then be adhered to this other end of the flag 102. In one embodiment, this other end of the flag 102 is rolled, or folded, slightly around the secondary dowel 120 enough to allow for that portion of the flag 102 to be stitched around the secondary dowel 120. In another embodiment, another type of adherent (e.g., glue) may be utilized to adhere the secondary dowel 120 to the flag 102.

Optionally, one or more stoppers 122 (e.g., rubber caps) may be positioned over the ends of the secondary dowel 120 to prevent, or minimize, tearing of the flag 102 that may result from rough edges of the secondary dowel 120 contacting the flag 102.

The secondary dowel 120 provides a number of different functionalities. Firstly, it prevents the flag 102 from being completely retracted within the enclosure shell 170, thereby always allowing the user to grasp a portion of the flag 102 to pull the flag 102 from the enclosure shell 170 for release of the flag 102 from the enclosure shell 170. Secondly, the secondary dowel 120 prevents entanglement of the flag 102 in its released form. Given the weight of the secondary dowel 120, the flag 102 is less likely to get twisted.

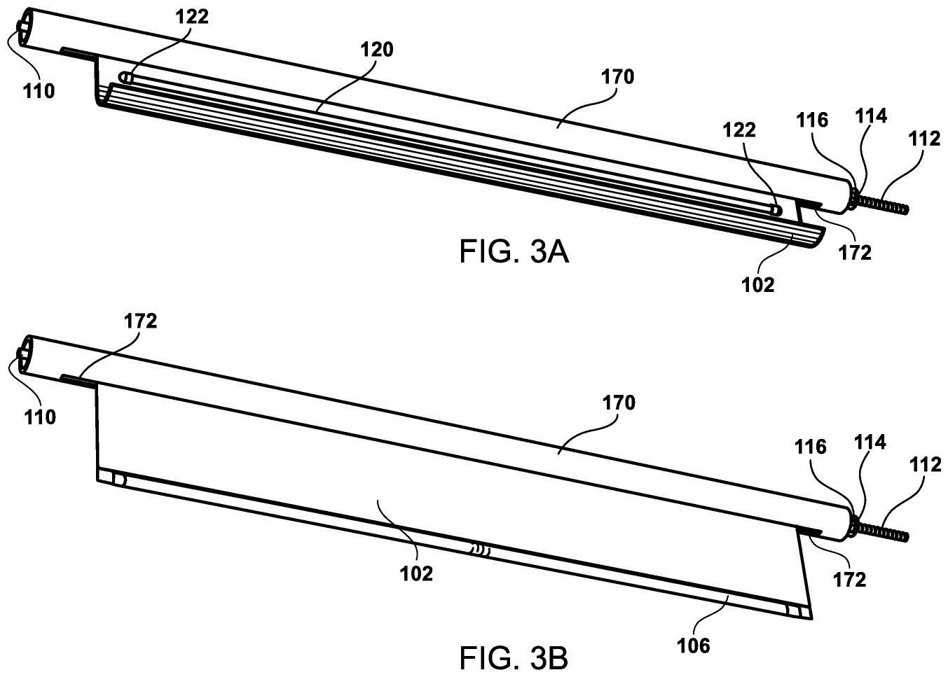

FIGS. 3A and 3B illustrate an example of the secondary dowel 120 being adhered to the flag 102. For instance, FIG. 3A illustrates the secondary dowel 120 being positioned at one end of the flag 102. Also, FIG. 3B illustrates a portion of the flag 102 being stitched over the secondary dowel 120.

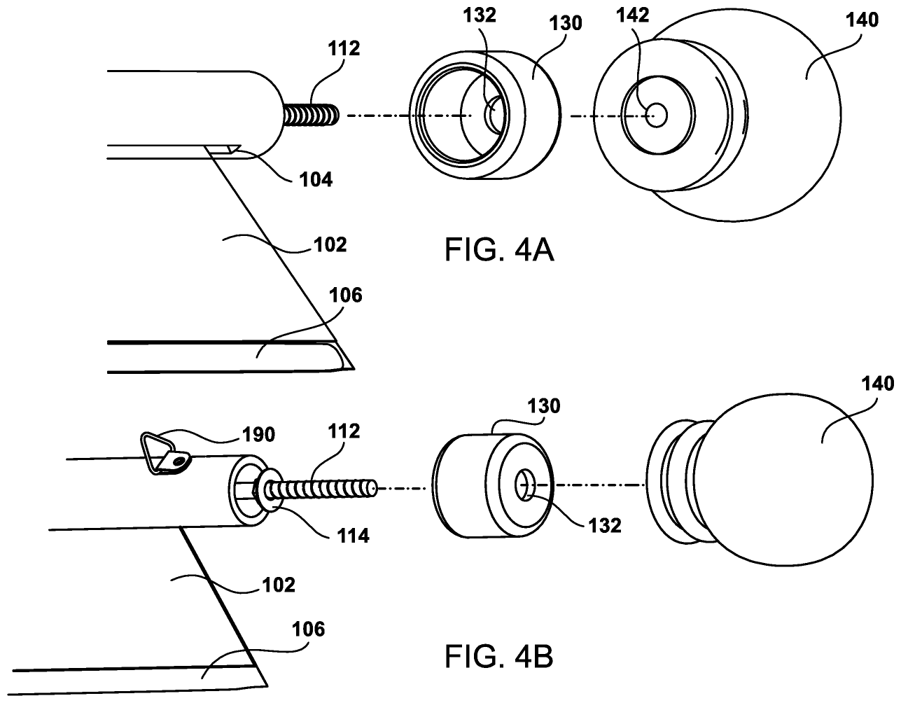

Furthermore, FIGS. 4A and 4B illustrate expanded views of the knob 140 engaging the cap 130, which connects to the enclosure shell 170. In particular, FIG. 4A illustrates a front perspective view of the knob 140 as it is about to engage the cap 130. Furthermore, FIG. 4B illustrates a side perspective view of the knob 140 illustrated in FIG. 4A.

Additionally, FIGS. 5A and 5B illustrate the detachable handle 180 attaching to the enclosure shell 170. For example, FIG. 5A illustrates the detachable handle 180 being attached to the bushing core 164 through the bushing casing 162. A washer 166 may be attached to the bushing casing 162. Further, FIG. 5B illustrates an expanded view of the detachable handle 180 being attached to the enclosure shell 170.

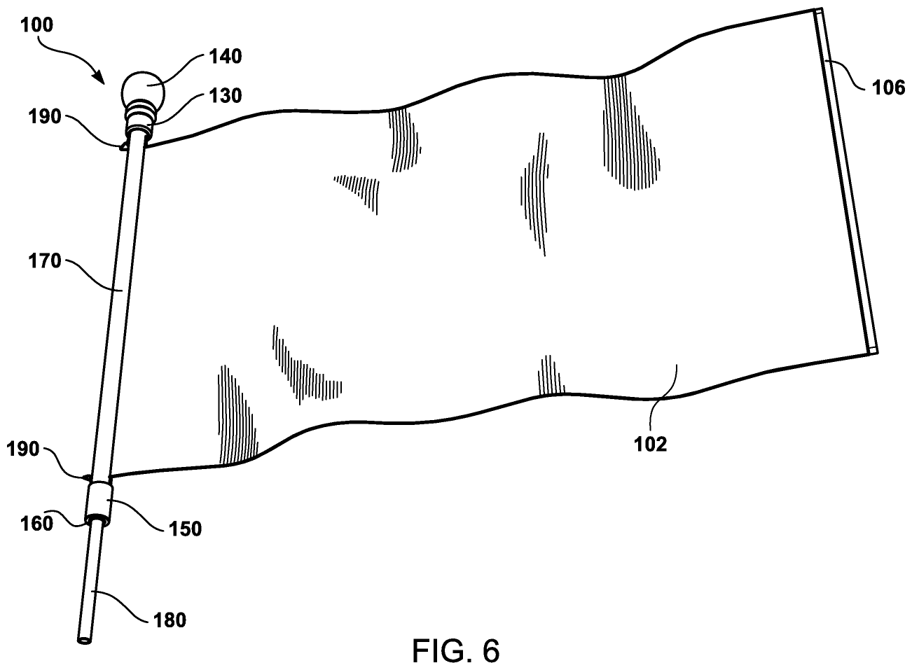

FIG. 6 illustrates an assembled retractable flag enclosure apparatus 100 illustrated in FIG. 1. The flag 102 is illustrated as being released from the retractable flag enclosure apparatus 100. Furthermore, the connection mechanisms 190 (e.g., hooks, clips, etc.) are illustrated as being attached to the enclosure shell 170 to allow for handing of the assembled retractable flag enclosure apparatus 100. The connection mechanisms 190 allow for horizontal or vertical hanging of the flag 102.

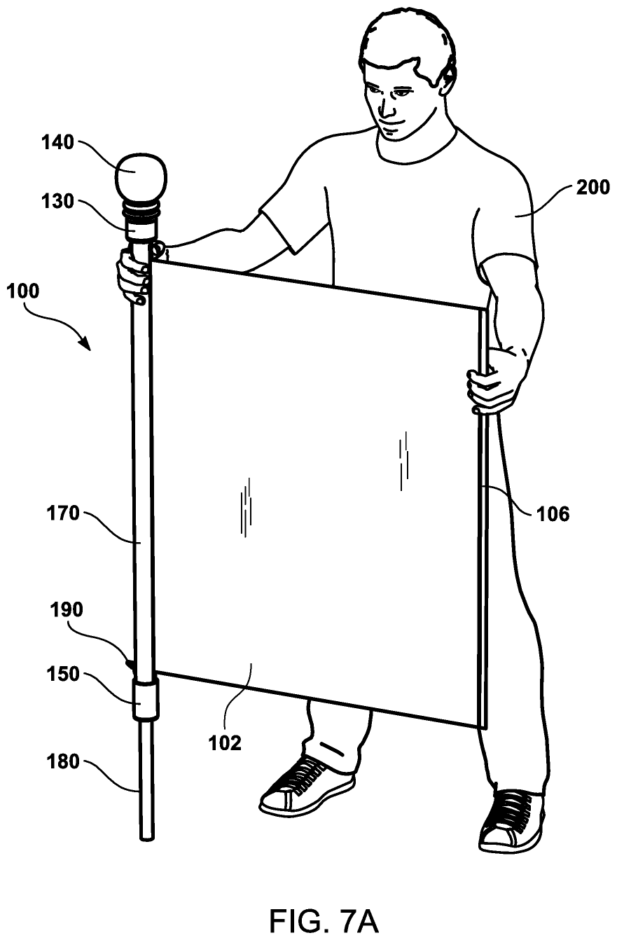

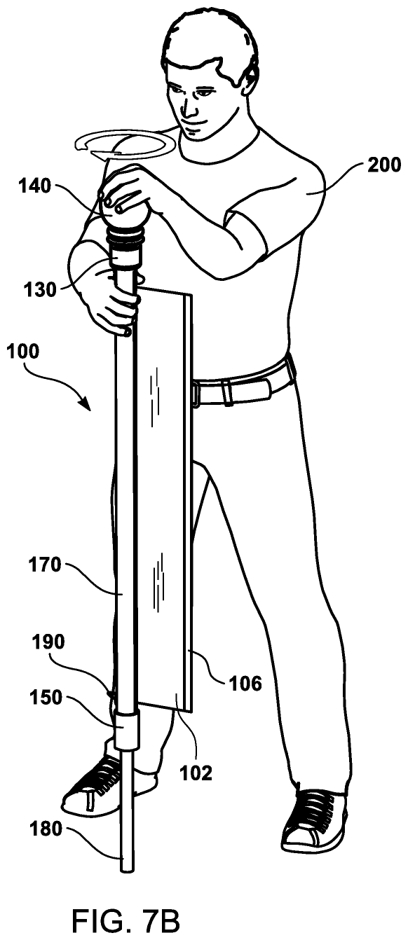

FIGS. 7A and 7B illustrate a user 200 operating the assembled retractable flag enclosure apparatus 100, illustrated in FIG. 6. In particular, FIG. 7A illustrates the user 200 pulling the flag 102, via the secondary dowel enclosure 106, from the enclosure shell 170. Furthermore, FIG. 7B illustrates the user 200 twisting the knob 140 to retract the flag 102 within the enclosure shell 170.

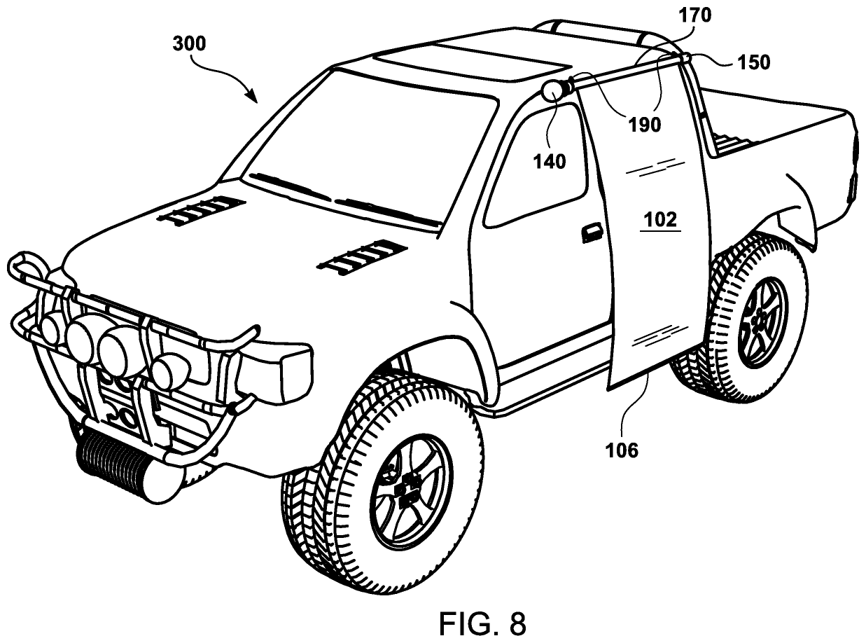

As an example, FIG. 8 illustrates the assembled retractable flag enclosure apparatus 100 being vertically hung from a vehicle 300. For instance, the connection mechanisms 190 may be connected to one or more receivers (e.g., hooks, clips, fasteners, nails, bolts, points, etc.) positioned on the vehicle 300, or a rack attached thereto. As another example, the assembled retractable flag enclosure apparatus 100 may be hung from a canopy via clips.

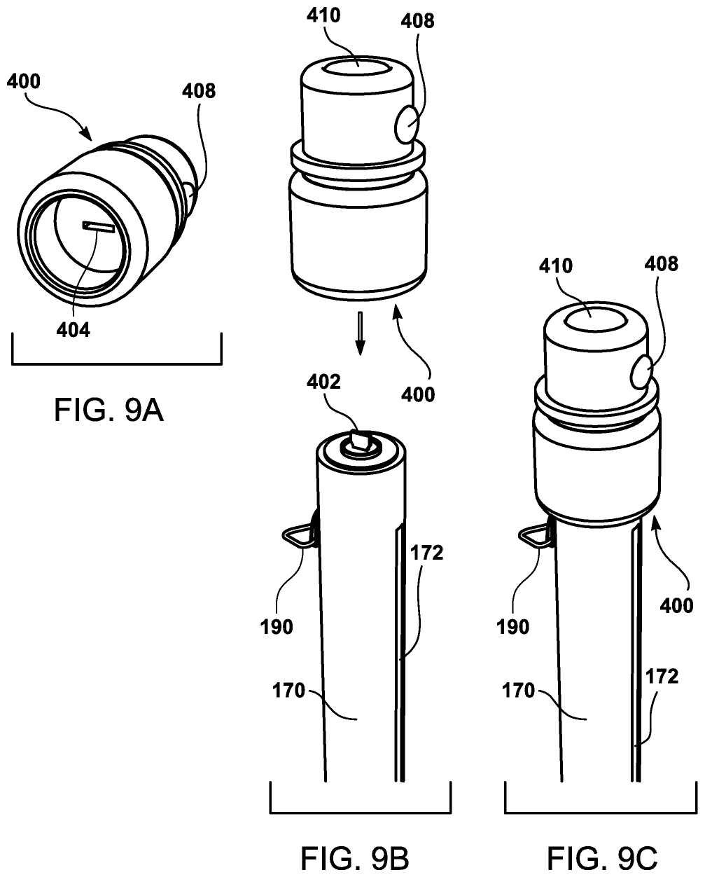

In an alternative embodiment, as illustrated in FIGS. 9A-9C, a spring-loaded mechanism may be utilized to automatically retract the flag 102 within the enclosure shell 170. In particular, FIG. 9A a socket 404 within a cap 400. FIG. 9B illustrates a spring roller 402, integrated within the enclosure shell 170, that engages the socket 404 of the cap 400. In essence, the spring roller 402 may be spring-loaded to automatically retract the flag 102 within the aperture 172 of the enclosure shell 170 upon the user 200 pulling on the flag 102.

Furthermore, a light 408 may be positioned on the cap 400 to allow the user 200 to light up the flag at night. For instance, an activator 410 (e.g., button, switch, etc.) may activate the lighting mechanism 408 (e.g., light emitting diode (“LED”)). In another embodiment, the lighting mechanism 408 is positioned along the enclosure shell 170, rather than the cap 400. As an example, if the user 200 is at a sporting event, the user 200 may emit light toward the flag 102 to illuminate the flag 102 so that it is visible to others at the sporting event. More than one lighting mechanism 408 may be utilized.

FIG. 9B illustrates the cap 400 being positioned on the spring roller 402. Finally, FIG. 9C illustrates the retractable flag enclosure apparatus 100 with the spring roller 402.

In another embodiment, the retractable flag enclosure apparatus 100 may be motorized. For example, an activator (e.g., button) may be activated by the user 200 to automatically move, via a motor, the flag 102 in and out of the enclosure shell 170.

In yet another embodiment, a weather strip may be positioned over part, or the entirety, of the aperture 172. For example, a zipper may be used to open a fabric covering over the aperture 172. As another example, the weather strip may be a plastic strip that is peeled from the aperture 172. The weather strip may prevent, or minimize, moisture from contacting the flag 102, which could damage the flag 102.

Additionally, a strap may be attached to the enclosure shell 170. Accordingly, the user 200 may easily carry the retractable flag enclosure apparatus 100 when travelling.

It is understood that the apparatuses described herein may also be applied in other types of apparatuses. Those skilled in the art will appreciate that the various adaptations and modifications of the embodiments of the apparatuses described herein may be configured without departing from the scope and spirit of the present apparatuses. Therefore, it is to be understood that, within the scope of the appended claims, the present apparatuses may be practiced other than as specifically described herein.

I claim:

1. A retractable flag enclosure apparatus comprising:
an enclosure shell having an aperture;
a knob operably attached to a top end of the enclosure shell;
a primary dowel;
a secondary dowel; and
a flag, the flag having a first end adhered to the primary dowel, the flag and the primary dowel being positioned within the enclosure shell such that a portion of the flag is retracted through the aperture via motion applied to the knob and a portion of the flag is pulled through the aperture, the flag having a second end that is adhered to the secondary dowel such that the secondary dowel is positioned on the exterior of the aperture and prevented from entering the enclosure shell.

2. The retractable flag enclosure apparatus of claim 1, further comprising a detachable handle that is operably connected to a bottom portion of the enclosure shell.

3. The retractable flag enclosure apparatus of claim 1, further comprising one or more connector mechanisms positioned along the exterior of the enclosure shell, the one or more connector mechanisms connecting the enclosure shell in a vertical manner to a structure.

4. The retractable flag enclosure apparatus of claim 1, further comprising one or more connector mechanisms positioned along the exterior of the enclosure shell, the one or more connector mechanisms connecting the enclosure shell in a horizontal manner to a structure.

5. The retractable flag enclosure apparatus of claim 1, wherein the enclosure shell is cylindrically-shaped.

6. The retractable flag enclosure apparatus of claim 1, wherein the enclosure shell is a pipe constructed from a material selected from the group consisting of: PVC, bamboo, metal, wood, carbon fiber, and fiberglass.

7. The retractable flag enclosure apparatus of claim 1, further comprising a lighting mechanism that emits light toward the flag, the lighting mechanism being positioned toward an end of the shell enclosure.

8. The retractable flag enclosure apparatus of claim 7, further comprising an activator that activates the lighting mechanism.

9. The retractable flag enclosure apparatus of claim 8, wherein the activator is selected from the group consisting of: a button, a switch, and a dial.

10. The retractable flag enclosure apparatus of claim 1, wherein the flag comprises a secondary dowel enclosure that encloses the secondary dowel.

11. A retractable flag enclosure apparatus comprising:
an enclosure shell having an aperture;
a spring roller attached to a top end of the enclosure shell;
a primary dowel;
a secondary dowel; and
a flag, the flag having a first end adhered to the primary dowel, the flag and the primary dowel being positioned within the enclosure shell such that a portion of the flag is retracted through the aperture via the spring roller and a portion of the flag is pulled through the aperture, the flag having a second end that is adhered to the secondary dowel such that the secondary dowel is positioned on the exterior of the aperture and prevented from entering the enclosure shell.

12. The retractable flag enclosure apparatus of claim 11, further comprising a detachable handle that is operably connected to a bottom portion of the enclosure shell.

13. The retractable flag enclosure apparatus of claim 11, further comprising one or more connector mechanisms positioned along the exterior of the enclosure shell, the one or more connector mechanisms connecting the enclosure shell in a vertical manner to a structure.

14. The retractable flag enclosure apparatus of claim 11, further comprising one or more connector mechanisms positioned along the exterior of the enclosure shell, the one or more connector mechanisms connecting the enclosure shell in a horizontal manner to a structure.

15. The retractable flag enclosure apparatus of claim 11, wherein the enclosure shell is cylindrically-shaped.

16. The retractable flag enclosure apparatus of claim 11, wherein the enclosure shell is a pipe constructed from a material selected from the group consisting of: PVC, bamboo, metal, carbon fiber, and fiberglass.

17. The retractable flag enclosure apparatus of claim 11, further comprising a lighting mechanism that emits light toward the flag, the lighting mechanism being positioned toward an end of the shell enclosure.

18. The retractable flag enclosure apparatus of claim 17, further comprising an activator that activates the lighting mechanism.

19. The retractable flag enclosure apparatus of claim 18, wherein the activator is selected from the group consisting of: a button, a switch, and a dial.

20. The retractable flag enclosure apparatus of claim 11, wherein the flag comprises a secondary dowel enclosure that encloses the secondary dowel.
